(19) United States
(12) Patent Application Publication
(10) Pub. No.: US 2025/0356438 A1
(43) Pub. Date: Nov. 20, 2025

(54) POWER GRID INTELLIGENCE: AI PLATFORM FOR INFRASTRUCTURE INSPECTION AND LOCALIZATION

(71) Applicant: NEC Laboratories America, Inc., Princeton, NJ (US)

(72) Inventors: Zhuocheng JIANG, Plainsboro, NJ (US); Yue TIAN, Princeton, NJ (US); Yangmin DING, East Brunswick, NJ (US); Sarper OZHARAR, Pennington, NJ (US); Ting WANG, West Windsor, NJ (US)

(73) Assignee: NEC Laboratories America, Inc., Princeton, NJ (US)

(21) Appl. No.: 19/204,978

(22) Filed: May 12, 2025

Related U.S. Application Data
(60) Provisional application No. 63/648,698, filed on May 17, 2024.

(51) Int. Cl. G06Q 50/06; G01S 19/14; G06T 7/00

(52) U.S. Cl. CPC G06Q 50/06; G01S 19/14; G06T 7/0002; G06T 2207/30184

(57) ABSTRACT

Disclosed is an artificial intelligence-based platform for infrastructure inspection, localization and maintenance of power grid structures that advantageously allows electrical utility service providers to evaluate the condition of distribution grid components at scale before failures. Our inventive systems, and methods of the platform employ a vehicle-mounted, camera-based inspection system that passively collects maintenance-related data during routine operation. A vehicle mounted computing platform—coupled with multiple sensors including stereo cameras, inertial measurement unit, and global positioning system—are combined with AI powered software that provides multiple monitoring applications including utility pole detection, pole GPS location, situational awareness/object recognition of any pole-mounted instruments, and anomaly detection resulting from weather-related or other events.

### CROSS-REFERENCE TO RELATED APPLICATIONS

This application claims the benefit of U.S. Provisional Patent Application Ser. No. 63/648,698 filed May 17, 2024, the entire contents of which is incorporated by reference as if set forth at length herein.

### FIELD OF THE INVENTION

This application relates generally to infrastructure inspection and maintenance. More particularly, it pertains to an artificial intelligence (AI) platform for infrastructure inspection, localization, and maintenance of power grid structures.

### BACKGROUND OF THE INVENTION

Thorough inspection and maintenance of utility poles provides significant challenges to utility companies, particularly with respect to ensuring reliable power distribution through unpredictable weather events. Since nearly 90% of all power outages in the U.S. are due to disruptions in the power distribution system caused by harsh weather conditions, regular inspection and maintenance of distribution components including utility poles is essential for preventing failures before they occur. Traditionally, pole inspections have been conducted manually, which can be time-consuming and prone to errors. Accordingly, improved inspection and maintenance methodologies along with supporting technologies would represent a welcome addition to the art.

### SUMMARY OF THE INVENTION

An advance in the art is made according to aspects of the present disclosure directed to an artificial intelligence-based platform for infrastructure inspection, localization and maintenance of power grid structures that advantageously—and in sharp contrast to the prior art—allows electrical utility service providers to evaluate the condition of distribution grid components at scale before failures.

In further contrast to the prior art, our inventive systems, and methods employ a vehicle-mounted, camera-based inspection system that passively collects maintenance-related data during routine operation. A vehicle mounted computing platform-coupled with multiple sensors including stereo cameras, inertial measurement unit, and global positioning system. Such computing platform is combined with AI powered software that provides multiple monitoring applications including utility pole detection, pole GPS location, situational awareness/object recognition of any pole-mounted instruments, and anomaly detection resulting from weather-related or other events.

### BRIEF DESCRIPTION OF THE DRAWING

FIG. 1 is a schematic diagram showing an illustrative edge platform mounted on vehicle for real-time applications according to aspects of the present disclosure.

FIG. 2 is a schematic diagram showing illustrative overview of our inventive procedural flow according to aspects of the present disclosure.

FIG. 3 is a schematic diagram showing illustrative real time utility pole detection according to aspects of the present disclosure.

FIG. 4 is a schematic diagram showing illustrative utility pole global positioning system location calculation and mapping according to aspects of the present invention.

FIG. 5 is a schematic diagram showing illustrative real-time infrastructure detection according to aspects of the present disclosure.

FIG. 6 is a schematic diagram showing vegetation overgrowth detection and poler damage response according to aspects of the present invention.

FIG. 7 is a schematic block diagram showing illustrative hardware and software operating components of systems, methods, and structures according to aspects of the present disclosure.

FIG. 8 is a schematic diagram showing illustrative computer system in which methods of the instant disclosure may be executed.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

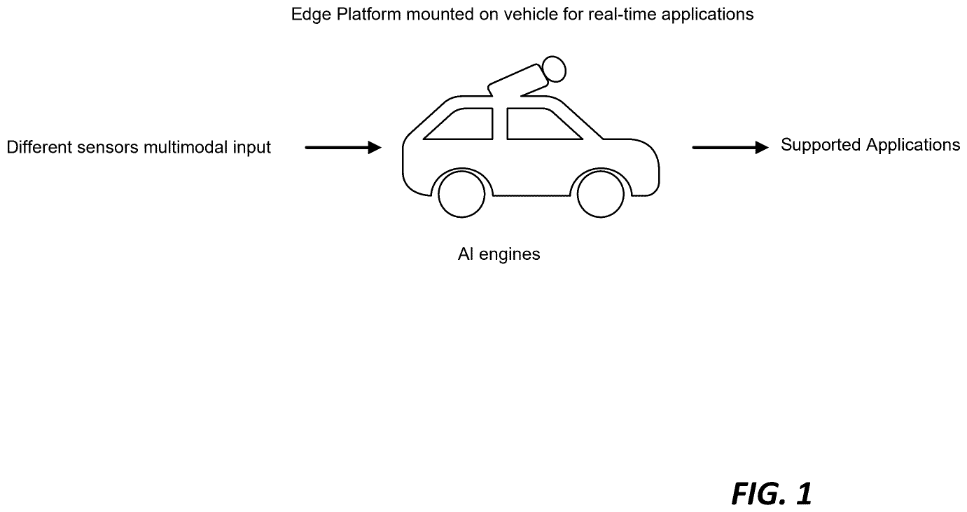

FIG. 1 is a schematic diagram showing an illustrative edge platform mounted on vehicle for real-time applications according to aspects of the present disclosure.

With reference now to that figure, it may be observed that our inventive vehicle-mounted edge platform includes a number of different sensors to devaluate the electrical distribution grid at scale. More particularly, a vehicle may include imaging, radar, lidar, sonar and other sensors including positional sensors such as GPS sensors and/or inertial sensors that are used to determine the conditions and locations of electrical distribution components that are to be monitored by the edge platform. Artificial Intelligence (AI) engines operating within the vehicle mounted edge platform interpret the sensor data and provide output to supported applications for reporting/alerting operations personnel or other systems as necessary. Inasmuch as the vehicle systems may be networked to cloud based resources, larger, remote, cloud based systems, models, and analysis systems may be made available to the remote, vehicle mounted systems.

As will be understood and appreciated, our inventive systems and methods help electric utilities evaluate the condition of the distribution grid at-scale with vehicle-mounted cameras and artificial intelligence software. We designed the camera-based inspection system and collect data passively during routine operations. Our AI-based software supports multiple applications and enables utility operators to take control over their asserts.

Advantageously, our innovative hardware platform, designed to be mounted on vehicles, supports real-time applications. This platform utilizes a stereo camera to capture video streams and generate disparity maps of the surrounding scene. A specialized pole detection algorithm processes the video to identify poles. Concurrently, a tailored navigation algorithm computes the pole's GPS coordinates, leveraging the vehicle's GPS data. High-resolution images are captured, upon which an infrastructure detection algorithm is applied to identify and assess the condition of the equipment.

As may be observed in the figure, a mountable computing platform combines multiple sensors, including stereo camera(s), inertial measurement unit, and GPS modules for detecting/locating utility equipment including utility poles and their environmental conditions. Accompanying software includes AI powered software that supports multiple applications such as utility pole detection, pole GPS location determination based on vehicle GPS location, situational awareness/object recognition of instruments mounted on the utility poles and anomaly detection of conditions caused by weather or human or other activities.

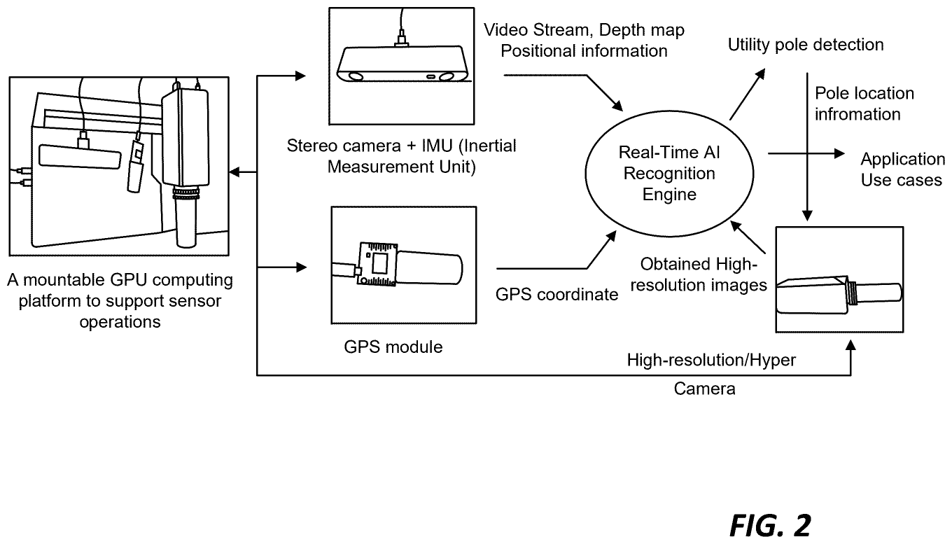

FIG. 2 is a schematic diagram showing illustrative overview of our inventive procedural flow according to aspects of the present disclosure.

With reference to that figure, there is shown the mountable GPU computing platform that supports sensor operation. The stereo cameras and inertial measurement unit (IMU) and GPS module provide video stream, depth map, positional information and GPS coordinates to a real-time AI recognition engine that provides a variety of useful analysis of the information including utility pole detection, pole location, and application use cases. High resolution images or other data generated by pole mounted cameras/instruments provide further data back to the AI system for subsequent training and analysis.

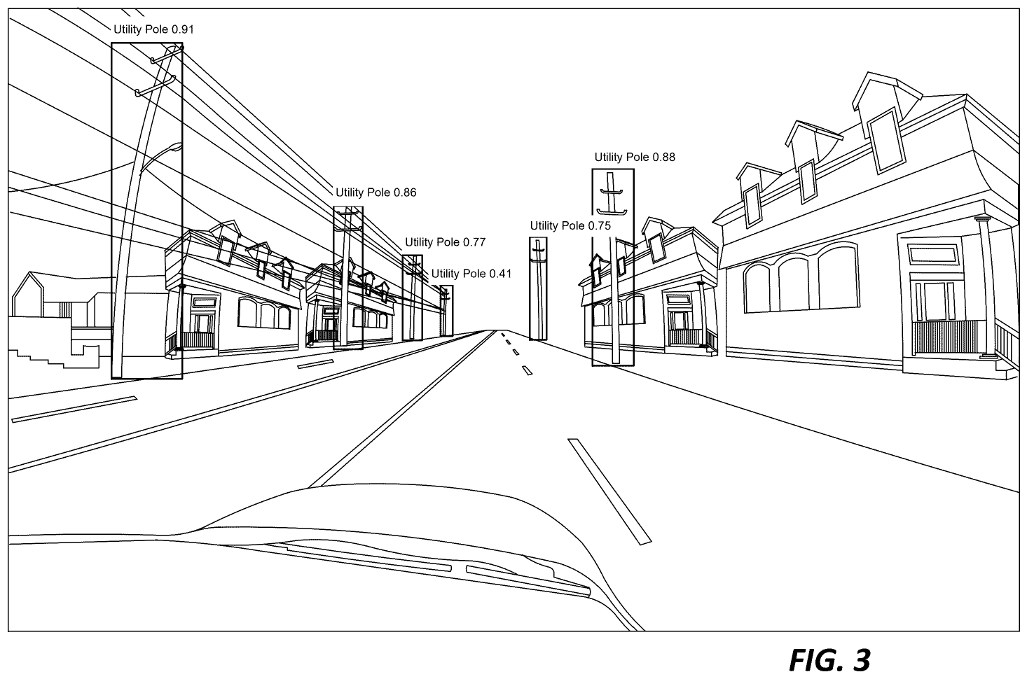

FIG. 3 is a schematic diagram showing illustrative real time utility pole detection according to aspects of the present disclosure.

Based on the captured images from the cameras, real time pole detection is made by the mobile system.

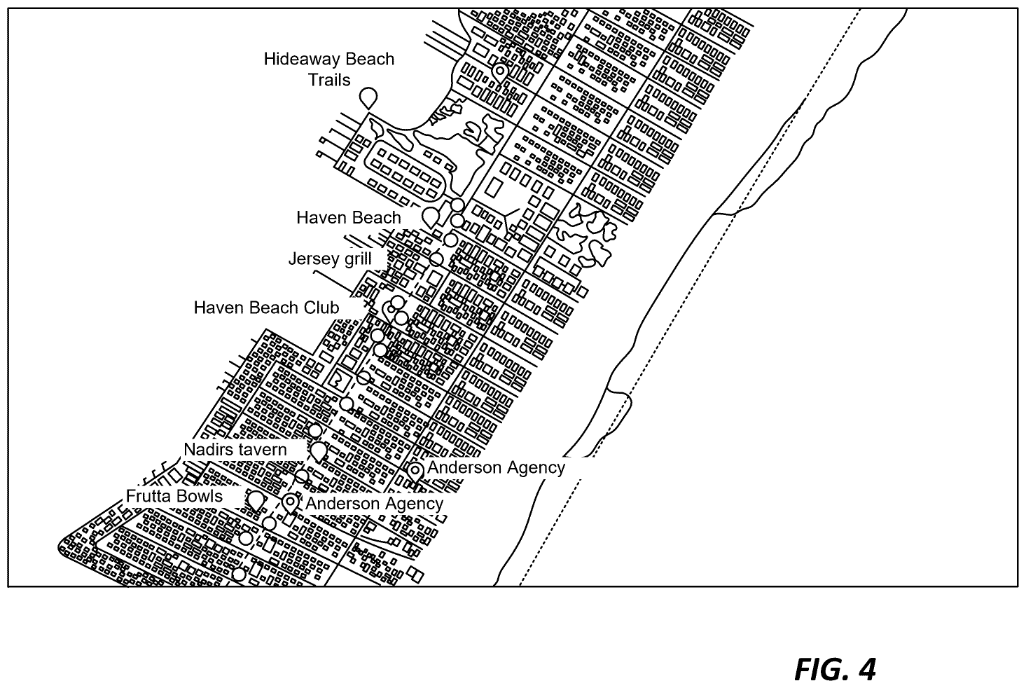

FIG. 4 is a schematic diagram showing illustrative utility pole global positioning system location calculation and mapping according to aspects of the present invention.

The GPS location of a utility pole may be calculated and mapped for subsequent review and maintenance dispatch based on vehicle GPS location and depth information obtained from—for example—a disparity map.

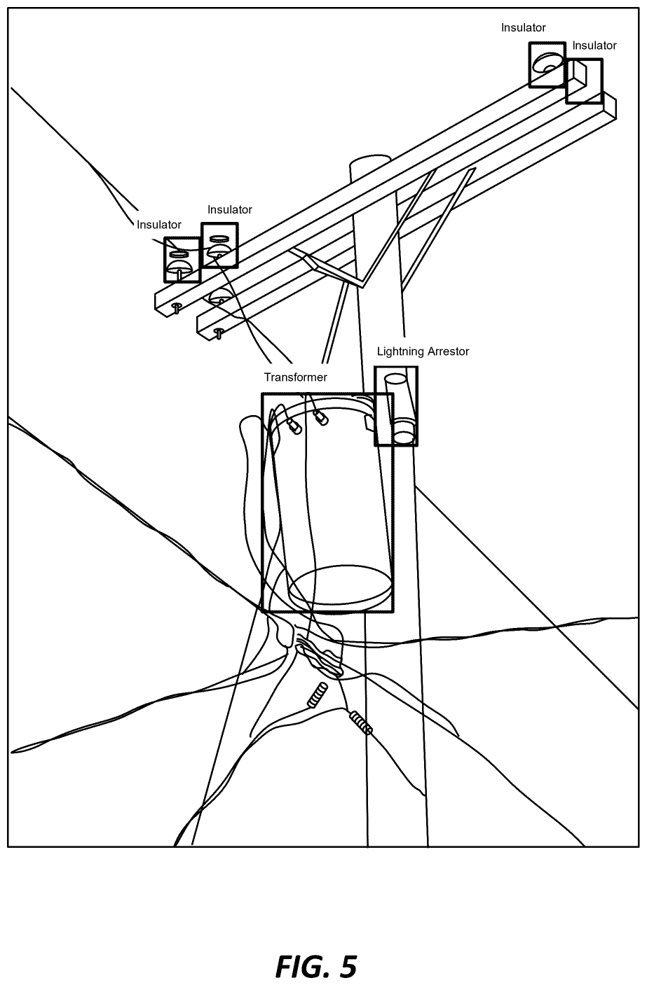

FIG. 5 is a schematic diagram showing illustrative real-time infrastructure detection according to aspects of the present disclosure.

As those skilled in the art will readily understand and appreciate, electric utility companies mount a variety of essential instruments and equipment on utility poles to facilitate the distribution of electricity from substations to homes and businesses. These components are crucial for the safe and efficient operation of the electrical grid. Primary types of instruments and equipment typically found on a utility pole may include the following.

Primary Wires/Lines: These are the highest wires on the pole, carrying high-voltage electricity (e.g., 7,200 to 34,500 volts) from a substation into a service area.

Insulators: Made of non-conductive materials like porcelain, glass, or polymer, insulators prevent energized wires from directly contacting the pole or crossarms, ensuring that electricity stays within the conductors. They come in various sizes, with larger insulators indicating higher voltages.

Crossarms: These are horizontal wooden or composite structures bolted to the pole that support the primary wires and keep them separated from each other and the pole. Not all poles have crossarms, especially if they carry only a single conductor or are designed for specific configurations.

Transformers: Often appearing as large, grey cylindrical or barrel-shaped devices, transformers are vital for “stepping down” the high voltage from the primary lines to a lower, usable voltage (e.g., 120/240 volts in North America) suitable for homes and businesses.

Fuse Cutouts: Acting like a large fuse, these devices protect transformers and lines from overcurrents caused by faults or surges. If a problem occurs, the fuse element melts, opening the circuit and often dropping down to indicate a fault, preventing further damage to the system.

Lightning Arresters (Surge Arresters): These devices are designed to protect electrical equipment on the pole, particularly transformers, from dangerous power surges caused by lightning strikes or other transient voltages. They divert the excessive electrical current safely to the ground.

Neutral Wire: This wire provides a return path for electric current back to the substation and helps balance the electrical load on the system. It is typically located below the primary wires and often connected to the ground wire.

Secondary Lines (Service Drops): These wires carry the lower-voltage electricity from the transformer to individual homes and businesses. They are usually located below the transformer.

Ground Wire: A bare copper wire that runs down the length of the pole and into the ground. It provides a safe path for excess electricity (such as from a lightning strike or fault) to dissipate into the earth, protecting equipment and preventing hazardous voltages on the pole.

Reclosers: Similar in function to circuit breakers, reclosers are automated switches that can detect a fault, open the circuit to clear the fault, and then automatically reclose to restore power. They are used in circuits that may experience temporary faults (e.g., from falling tree branches) and can attempt to restore power multiple times before locking out.

Capacitors: These devices, often appearing as metal boxes or banks of cylindrical units, are used to improve the efficiency of power flow and regulate voltage on the distribution system, especially in areas with fluctuating electrical loads.

In addition to these electrical components, utility poles may also carry equipment for other services like telephone, cable television, and fiber optic internet, as well as streetlights, traffic signals, and increasingly, small cellular antennas, which are attached in designated “communication spaces” typically below the electrical equipment.

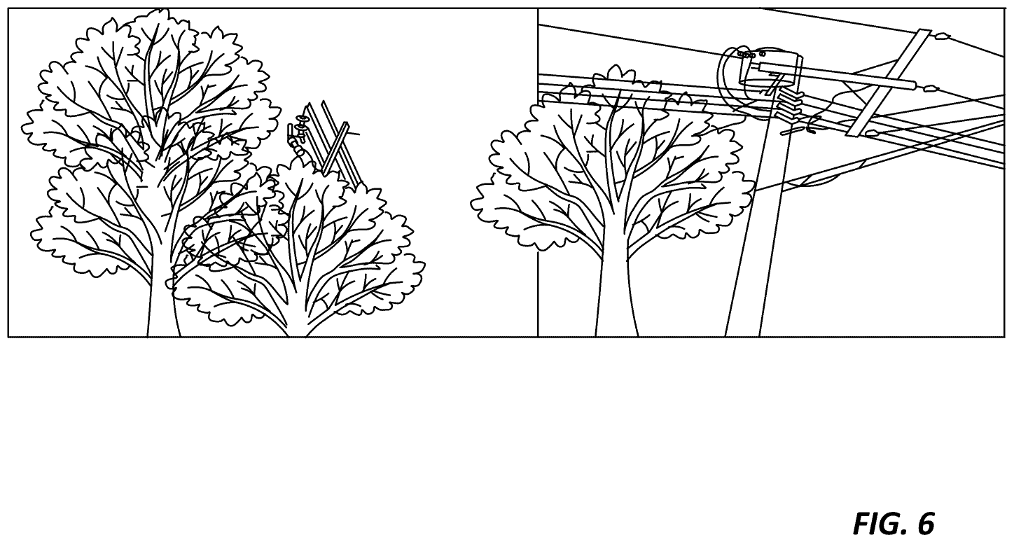

FIG. 6 is a schematic diagram showing vegetation overgrowth detection and poler damage response according to aspects of the present invention.

As illustratively shown in that figure, an illustrative hardware platform may include a stereo camera, an inertial measurement unit, a high resolution camera, and a GPS module among others. Software and AI platforms include real time pole detection, determining relative angle between vehicle and utility pole, high resolution image detection and determination of any instruments located on the utility poles and GPS location of the moving vehicle and of the utility pole. AI techniques provide for object detection of any pole mounted instruments as well as environmental conditions including vegetation contact.

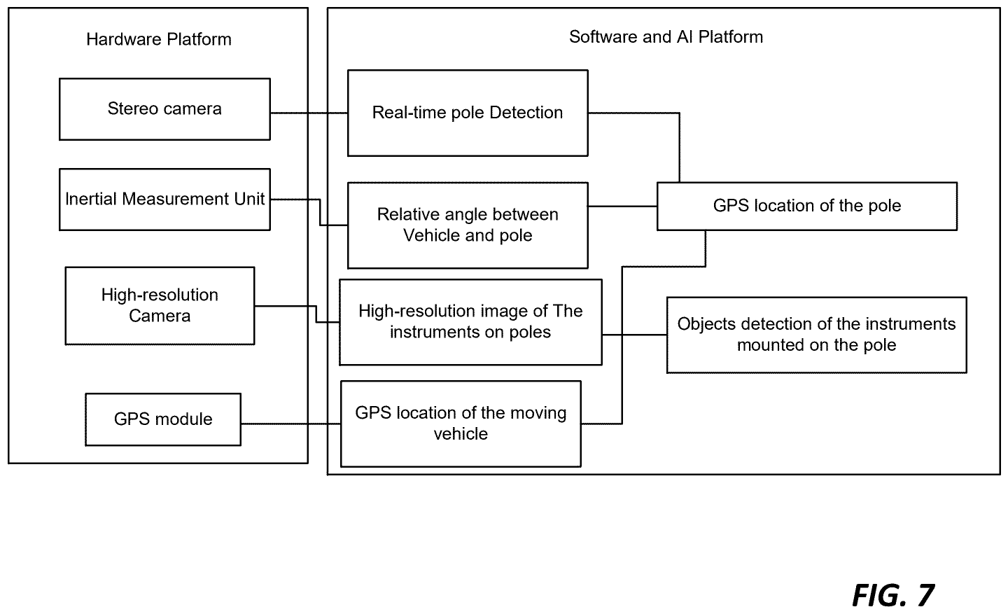

FIG. 7 is a schematic block diagram showing illustrative hardware and software operating components of systems, methods, and structures according to aspects of the present disclosure.

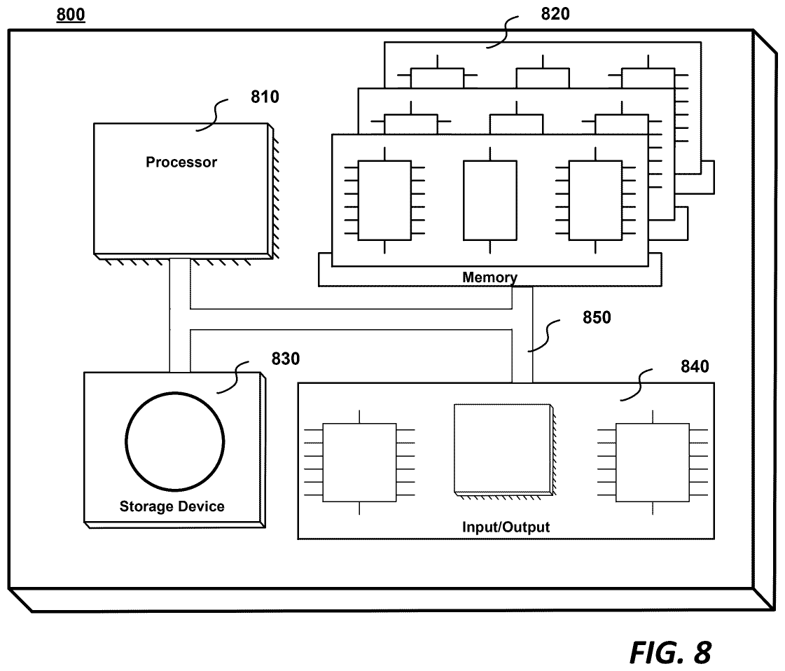

FIG. 8 is a schematic block diagram of an illustrative computing system that may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of a number of operating systems. The above-described methods of the present disclosure may be implemented on the computer system 800 as stored program control instructions.

Computer system 800 includes processor 810, memory 820, storage device 830, and input/output structure 840. One or more input/output devices may include a display 845. One or more busses 850 typically interconnect the components, 810, 820, 830, and 840. Processor 810 may be a single or multi core. Additionally, the system may include accelerators etc., further comprising the system on a chip.

Processor 810 executes instructions in which embodiments of the present disclosure may comprise steps described in one or more of the Drawing figures. Such instructions may be stored in memory 820 or storage device 830. Data and/or information may be received and output using one or more input/output devices.

Memory 820 may store data and may be a computer-readable medium, such as volatile or non-volatile memory. Storage device 830 may provide storage for system 800 including for example, the previously described methods. In various aspects, storage device 830 may be a flash memory device, a disk drive, an optical disk device, or a tape device employing magnetic, optical, or other recording technologies.

Input/output structures 840 may provide input/output operations for system 800.

At this point, those skilled in the art will understand and appreciate that we introduce a Deep Phase-Magnitude Network (DFMN) and point out that combining the filtering in time domain and frequency domain can significantly enhance the classification accuracy and improve the domain generalization ability. We divide the raw fiber sensing data into magnitude response and phase response for parallel feature representation learning. Furthermore, we propose a Phase Frequency Learnable Filter (PFLF) specifically designed for phase component learning, which effectively determines the frequency components crucial for enhancing rain detection accuracy. In the end, we formulate the phase-magnitude channel within a dual-path network and subsequently fuse the features for a comprehensive analysis. Extensive experiments and ablation studies demonstrate the effectiveness of our proposed method.

While we have presented our inventive concepts and description using specific examples, our invention is not so limited. Accordingly, the scope of our invention should be considered in view of the following claims.

1. A system for infrastructure inspection and localization comprising:
a motor vehicle including;
a stereo camera;
an inertial measurement unit;
a high-resolution camera;
a global positioning system (GPS) receiver; and
a computer system including a processor, the processor configured at least in part to
perform real-time utility pole detection;
perform utility pole GPS location determination and mapping;
perform real-time infrastructure detection; and
perform vegetation overgrowth detection and utility pole damage detection and utility pole response.

2. The system of claim 1 wherein the processor is configured to perform the real-time utility pole detection, utility pole GPS location determination and mapping, real-time infrastructure detection, and perform vegetation overgrowth detection and utility pole damage detection and utility pole response while the motor vehicle is moving.

3. The system of claim 2 further comprising an artificial intelligence (AI) engine configured to evaluate the operating condition of an electrical grid including the utility poles.

4. The system of claim 3 wherein the processor is configured to determine relative angles between the vehicle and a utility pole.

5. The system of claim 4 wherein the processor is configured to identify pole mounted instruments mounted on the utility pole.
